(19) United States
(12) Patent Application Publication
(10) Pub. No.: US 2025/0066134 A1
(43) Pub. Date: Feb. 27, 2025

(54) SCREW LIFTER WHICH LIFTS A TOY BALL

(71) Applicant: Langping Liu, Shantou (CN)

(72) Inventor: Langping Liu, Shantou (CN)

(21) Appl. No.: 18/236,418

(22) Filed: Aug. 22, 2023

(51) Int. Cl. B65G 33/04

(52) U.S. Cl. CPC B65G 33/04

(57) ABSTRACT

The present invention provides a spiral lifter that can lift the toy ball, including a base, a lifting component and a recycling component, the screw lifter structure is more stable, the life is longer, the shell pipe design is simple, consumers can be easier to build, the number of parts is less, the risk of missing parts in the assembly process is smaller, the abutment part is designed more securely, avoiding consumers from inserting fingers and clamping fingers when the assembly is not completed.

### TECHNICAL FIELD

The present invention relates to the technical field of screw lifter, in particular to a screw lifter which lifts a toy ball.

### BACKGROUND

Spiral lifter because it can improve the hands-on ability and expand thinking ability, and by the general public's favorite, but the market spiral lifter parts too much lead to disassembly inconvenience, and easy to lose parts, the main body of the shell pipeline design is complex, making it difficult for consumers to dismantle and build, and the abutment part of the pipeline part of the design is poor, easy to use when injured.

Based on the above problems, it is necessary to propose a new spiral lifter, the spiral lifter structure is more stable, longer life, shell piping design is simple, consumers are more likely to go to build, the number of parts is reduced, reducing the risk of missing parts in the assembly process, the abutment part of the design of a safer, to avoid the consumer in the unassembled time to insert the finger, pinch the finger.

### SUMMARY

A screw lifter which lifts a toy ball comprising a base, a lifting assembly and a recycling assembly,

The base includes a base housing and a drive assembly, with a first opening and a second opening provided in the base housing;

The lifting assembly includes a screw mechanism, a lifting pipe and a lifting inlet and a lifting outlet provided in the lifting pipe, wherein the lifting assembly is provided in the first opening, the screw mechanism is coupled to the drive assembly, and the lifting pipe wraps around the whole of the screw mechanism;

The recycling assembly comprises a recycling pipe and a recycling inlet and a recycling outlet provided on the recycling pipe, wherein the recycling assembly is provided in a second opening

wherein the longitudinal height of the recycling inlet is not higher than the longitudinal height of the lifting outlet and the longitudinal height of the recycling outlet is not lower than the longitudinal height of the lifting inlet;

When the screw mechanism is driven by the drive assembly, the screw mechanism can lift a toy ball entering from the lifting inlet and lifting it to the lifting outlet;

When the toy ball enters the recycling pipe through the recycling inlet, the toy ball relying on its own gravity quickly reaches the recycling outlet, comes out of the recycling outlet and enters the lifting inlet, and thus is lifted again by the screw mechanism, completing the reciprocating cyclic movement.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is an overall schematic diagram of the present invention;

FIG. 2 is an isometric views of the exploded structure of the base;

FIG. 3 is an isometric views of the components in the drive assembly;

FIG. 4 is an isometric views of the position of the motor housing in the base;

FIG. 5 is an isometric views of the position of the battery slot and the battery cover;

FIG. 6 is an isometric views of the position of the gear torsion member;

FIG. 7 is an isometric views of the position of the switch;

FIG. 8 is an isometric views of the structure of the switch;

FIG. 9 is a sectional views of a structural section of the base and the pipe portion above it;

FIG. 10 is an isometric views of the position of the protruding block;

FIG. 11 is a sectional views of a structural section of the lifting assembly;

FIG. 12 is an isometric views of the structure of the screw rod;

FIG. 13 is an isometric views of the position of the flange;

FIG. 14 is an isometric views of the structure of the lifting pipe unit;

FIG. 15 is a sectional views of the structure of the limiting block and the external portion;

FIG. 16 is a schematic diagram of the structure of the recycling assembly;

FIG. 17 is a schematic diagram of the structure of the recycling pipe unit;

FIG. 18 is an isometric views of the chute;

In the drawings:
1000, base; 1100, base housing; 1200, drive assembly; 1300, switch; 1500, motor housing; 1110, first opening; 1120, second opening; 1210, battery slot; 1211, battery cover; 1220, motor; 1230, gear set; 1240, gear torsion member; 1310, sliders; 1320, mount;
2000, lifting assembly; 2100, screw mechanism; 2200, lifting pipe; 2300, lifting inlet; 2400, lifting outlet; 2500, toy ball; 2600, limiting block; 2700, external portion; 2110, screw rod; 2111, central shaft; 2112, screw guide; 2113, connecting groove; 2120, triangular pin; 2130, joint; 2210, lifting pipe unit; 2211, main body portion; 2212, holding portion; 2213, joint; 2214, protruding block;
3000, recycling assembly; 3100, recycling pipe; 3110, recycling inlet; 3120, recycling outlet; 3111, joint; 3200, recycling pipe unit; 4000, chute.

### DESCRIPTION OF EMBODIMENTS

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items. As used in the description of the inventive concept and the appended claims, the singular forms “a,” “an,” and “the” are intended to include the plural forms as well, unless the context clearly indicates other.

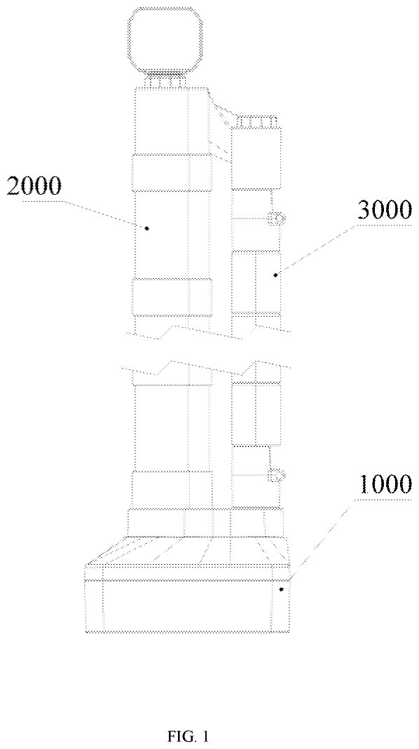

The present invention provides a liftable spiral lifter that includes base 1000, lifting assembly 2000 and recycling assembly 3000, as shown in FIG. 1.

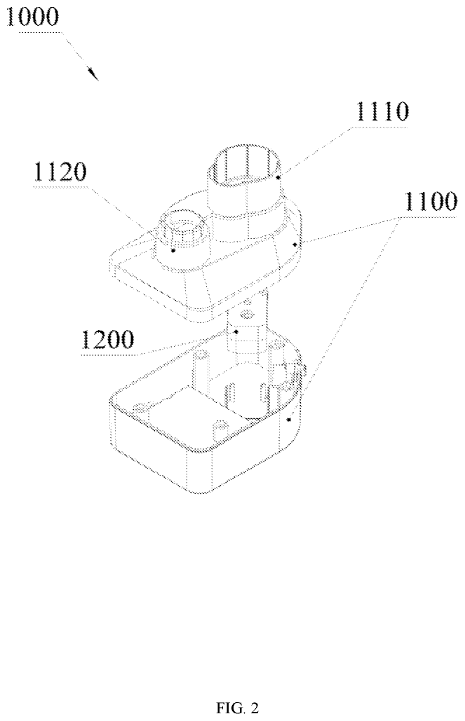

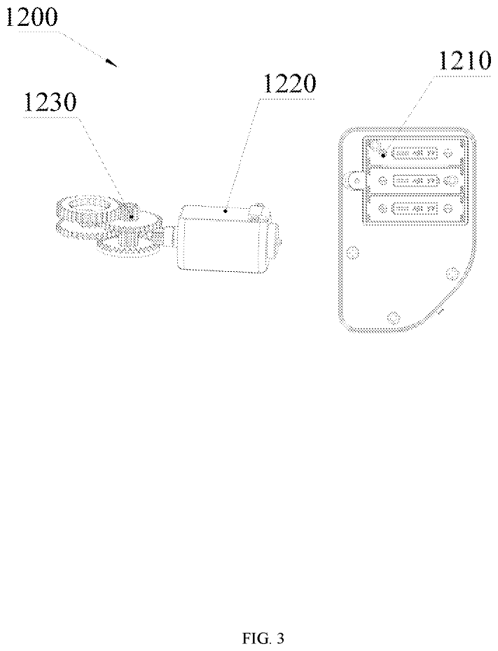

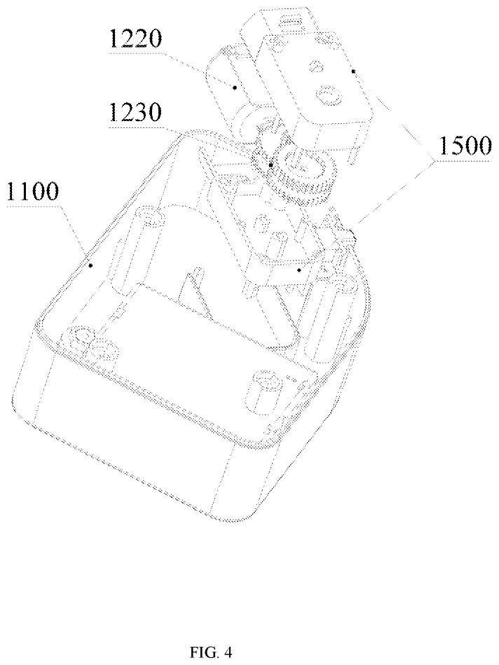

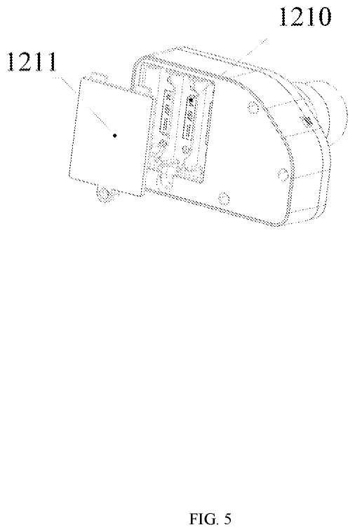

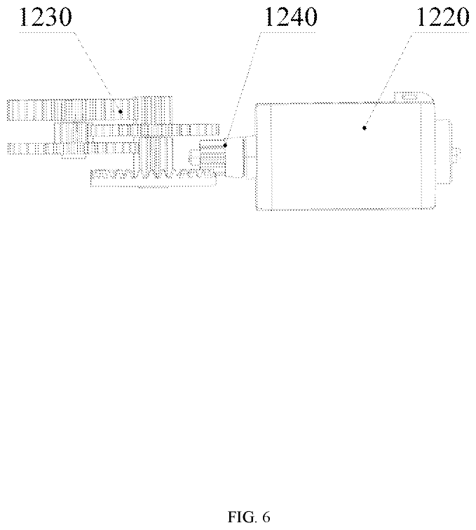

As shown in FIGS. 2 and 3, base 1000 comprises base housing 1100 and drive assembly 1200, first opening 1110 and second opening 1120 are provided on base housing 1100, in this embodiment, drive assembly 1200 comprises battery slot 1210, motor 1220 and gear set 1230, in this embodiment (as shown in FIG. 4), motor housing is provided inside base housing 1100, motor housing wraps motor 1220 and gear set 1230, motor housing is provided with base 1000 using a plug-in fixing, and a screw fixing connection is used between the upper and lower portions of motor housing. Further (as shown in FIG. 5), battery slot 1210 is provided with battery cover 1211, which is detachably connected to battery slot 1210 and screwed to battery slot 1210, and three 1.5 v batteries can be placed inside, and the electricity provided by the batteries will provide energy power for the whole screw lifter, (as shown in FIG. 6), and torque is transmitted between motor 1220 and gear set 1230 through gear torsion member 1240, and the gear end of gear torsion member 1240 is connected to gear set 1230 by meshing between the gear teeth. is connected by meshing and connecting between the gear teeth, and the other end of gear torsion member 1240 is connected by a plug connection.

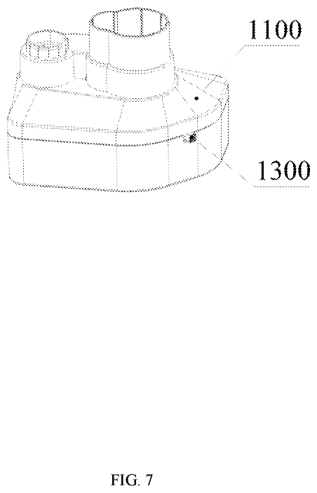

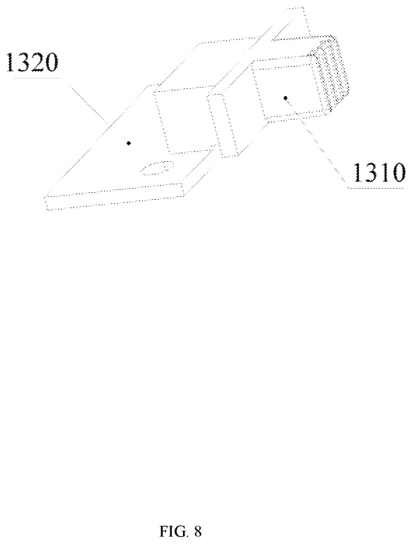

As shown in FIG. 7, in this embodiment, the outer surface of base housing 1100 is also provided with switch, (as shown in FIG. 8) switch includes sliders and mount, and mount and the bottom of base housing 1100 are fixedly connected to each other by means of plug connection, and a screw fixing post 1400 is also provided on base housing 1100, and the screw fixing post 1400 fixes the upper and lower portions of base housing 1100, so that they are not separated.

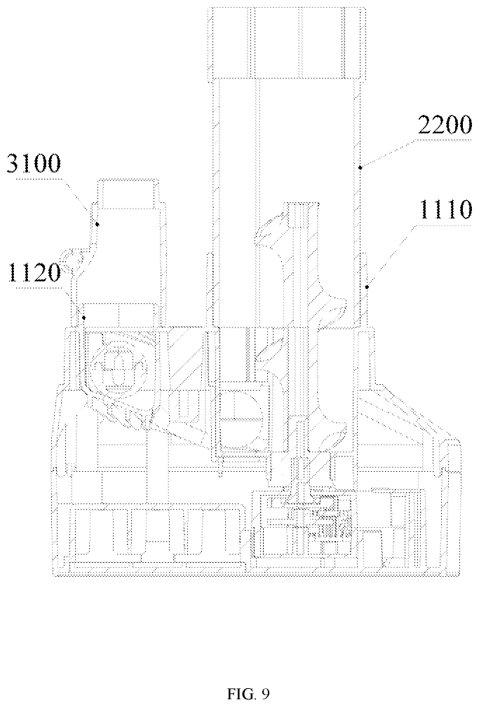

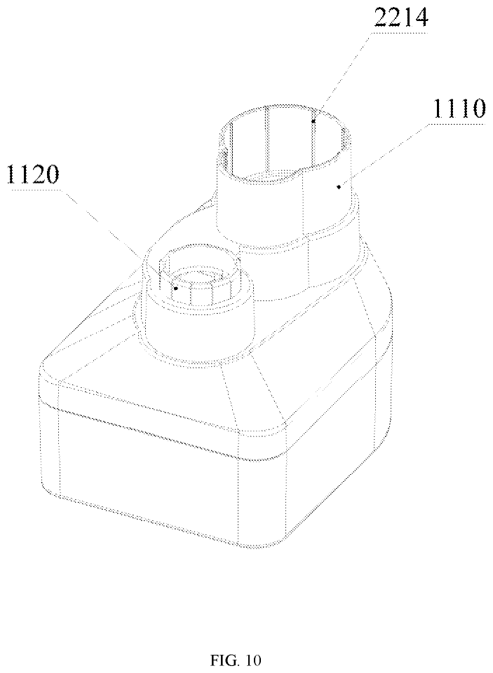

As shown in FIG. 9, in this embodiment, both first opening 1110 and second opening 1120 are configured as vertical pipes extending upwardly, with the lower end of first opening 1110 wrapped to, and second opening 1120 inserted inside the lower end of recycling pipe 3100, cooperating to form a sealed pipe structure design, and (as shown in FIG. 10) the inner wall of first opening 1110 is also provided with the setting of protruding block 2214, which is designed to be safer, avoiding the consumer inserting a finger and pinching the finger when the assembling is not completed. to the finger.

In other embodiments (not shown in the drawings), drive assembly 1200 can also be in the form of built-in battery, external power supply, or purely mechanical rack and pinion drive.

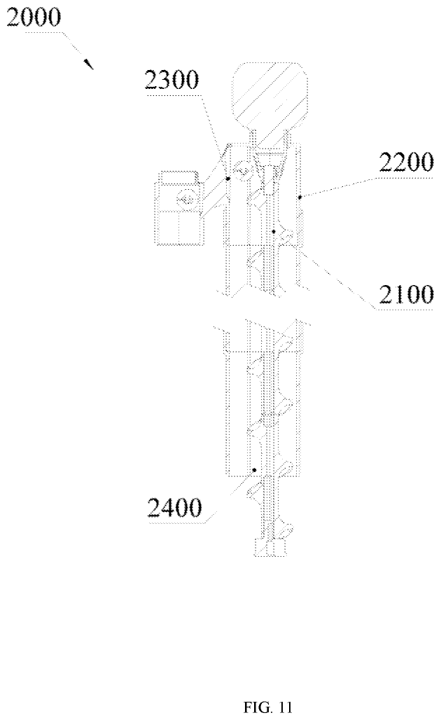

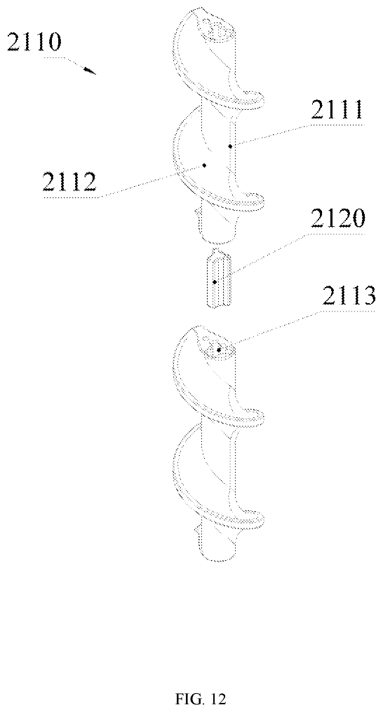

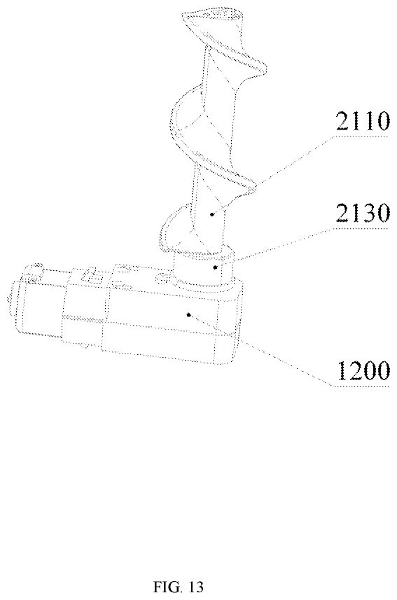

As shown in FIG. 11, lifting assembly 2000 comprises screw mechanism 2100, lifting pipe 2200 and lifting inlet 2300 and lifting outlet 2400 provided on lifting pipe 2200, lifting assembly 2000 being provided in first opening 1110, wherein screw mechanism 2100 comprises a plurality of sections screw rod 2110, (as shown in FIG. 12) each of said sections screw rod 2110 comprising central shaft 2111, screw guide 2112 provided around said central shaft 2111, and connecting groove 2113 provided at the end of said screw rod 2110. screw mechanism 2100 further comprising triangular pin 2120, a transmission connection being formed between each two sections screw rod 2110 by means of triangular pin 2120, wherein the ends of said triangular pin 2120 extend into the connecting groove 2113 of the two neighbouring sections screw rod 2110 respectively, so that the ends of the two neighbouring sections screw rod 2110 can be in contact, achieving a solid structural design of screw mechanism 2100 and improving the service life of the device, and furthermore (as shown in FIG. 13) the bottom of screw mechanism 2100 is connected to drive assembly 1200 by means of flange connected to drive assembly 1200.

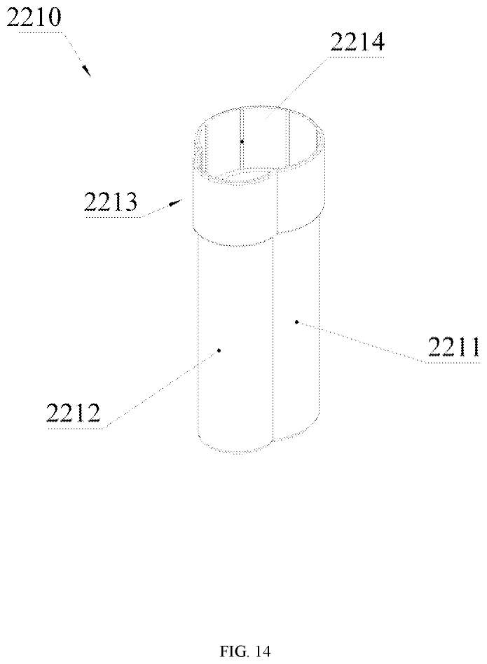

Further, in this embodiment, lifting inlet 2300 is provided at the bottom of lifting pipe 2200, and lifting outlet 2400 is provided at the top of lifting pipe 2200, and lifting pipe 2200 wraps around the whole of screw mechanism 2100, (as shown in FIG. 14) lifting pipe 2200 consists of a plurality of sections lifting pipe unit 2210 connected together, and each section lifting pipe unit 2210 consists of main body portion 2211 and holding portion 2212, and joint 2213 is provided at one end of lifting pipe unit 2210, and joint 2213 is provided at an inner wall of joint 2213 with protruding block 2214, and protruding block 2214 can secure another section lifting pipe unit 2210, allowing the lifting pipe unit 2210 to be plugged into each other. The pipes are connected in a simple manner, allowing consumers to build or reassemble them themselves when in use.

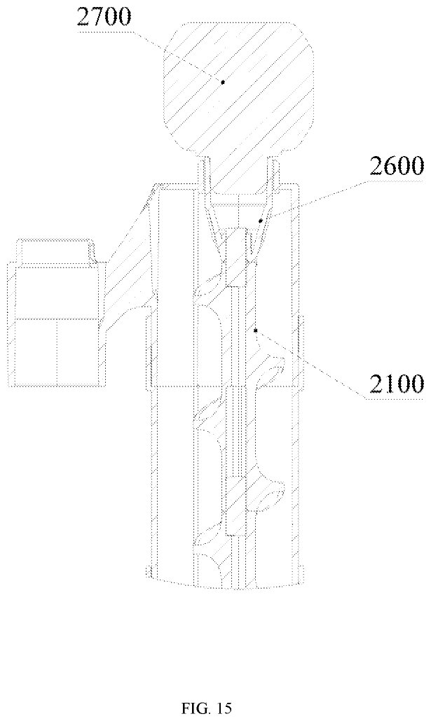

As shown in FIG. 15, in this embodiment, screw mechanism 2100 is provided with limiting block 2600 at the top, the shape of limiting block 2600 is set to be cylindrical at the upper part and inverted conical at the lower part, and the highest height at which toy ball 2500 rises within lifting pipe 2200 is the location where limiting block 2600 is situated, and furthermore, there is provided external portion 2700 above limiting block 2600, and the lower part of external portion 2700 is stretched out into limiting block 2600, so that external portion 2700 can be rotated in synchrony with screw mechanism 2100. The external portion 2700 is an object of a decorative nature, having the function of glowing or making sound, for example, it may be a rotating doll, and in other embodiments (not shown in the figures), it may be a decorative board having pictures arranged on it, or a device having music playing, playing different music in different environmental conditions to achieve different experiential effects.

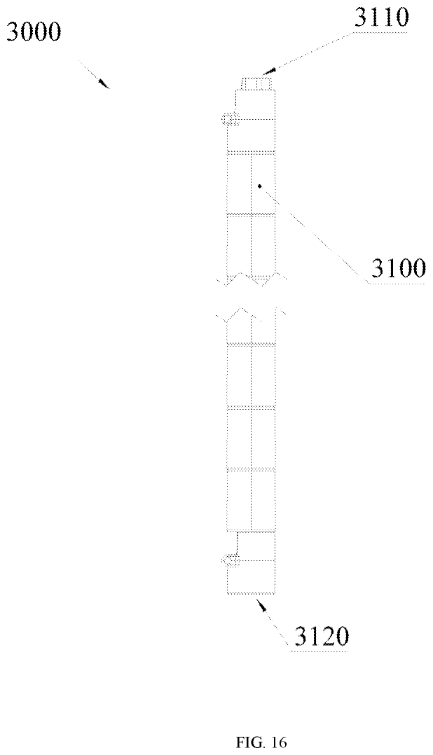

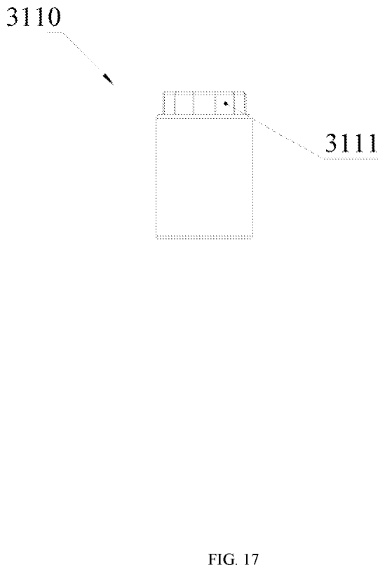

As shown in FIG. 16, recycling assembly 3000 comprises recycling pipe 3100 and recycling inlet 3110 and recycling outlet 3120 provided on recycling pipe 3100, a lower portion of recycling pipe 3100 is sleeved on second opening 1120, recycling pipe 3100 comprises a plurality of recycling pipe unit 3200, the lowermost recycling pipe unit 3200 and the uppermost recycling pipe unit 3200 of recycling pipe 3100 are arranged with openings through which they can be placed into recycling pipe 3100, (as shown in FIG. 17) recycling pipe unit 3200 is provided at one end with joint 3111, wherein the inner wall of joint 3111 is a smooth arcuate surface and the outer wall surface is enveloped by a plurality of rectangular surfaces, and the diameter of joint 3111 is smaller than the diameter of the other end of recycling pipe unit 3200, so that the plurality of recycling pipe unit 3200 can be inserted into each other.

In this embodiment, recycling pipe 3100 is placed in a vertical manner and the longitudinal height of recycling inlet 3110 is not higher than a longitudinal height of lifting outlet 2400 and the longitudinal height of recycling outlet 3120 is not lower than a longitudinal height of lifting inlet 2300. In other possible embodiments (not shown in the drawings), the recycling pipe 3100 can also be placed in a way that is inclined to the ground at a certain angle, or there is a certain angle with lifting pipe 2200 in the vertical direction, and furthermore, the recycling pipe 3100 can be a meandering and circling pipeline or any other track that can realize that the toy ball 2500 can be accessed from the recycling inlet 3110 and reach the recycling outlet 3120 after a certain distance, and such arrangement can make the whole equipment operation of the device more interesting.

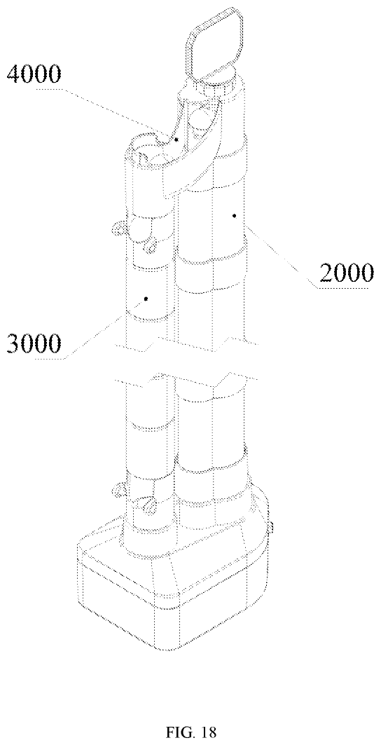

As shown in FIG. 18, further, lifting assembly 2000 and recycling assembly 3000 are connected by two chute 4000's, the two chute 4000's being provided between recycling outlet 3120 and lifting inlet 2300 and between recycling inlet 3110 and lifting outlet 2400, wherein the chute 4000's are provided in the form of a semi-wraparound with an opening at the upper end, and the chute 4000's between recycling outlet 3120 and lifting inlet 2300 are mounted in the base housing 1100's, and the toy ball 2500s can be moved in and out between lifting assembly 2000 and recycling assembly 3000 via the chute 4000's. in and out between lifting assembly 2000 and recycling assembly 3000.

In this embodiment, the arrangement of recycling pipe 3100 and lifting pipe 2200 is kept horizontal in the vertical direction, and in other embodiments (not shown in the drawings), the arrangement of recycling pipe 3100 and lifting pipe 2200 may be various, for example, the longitudinal height of recycling inlet 3110 is set to be lower than the longitudinal height of lifting outlet 2400, and the longitudinal height of recycling outlet 3120 is set to be higher than the longitudinal height of lifting inlet 2300, but recycling pipe 3100 and lifting pipe 2200 are arranged in a double helix, which makes the structure look more aesthetically pleasing.

Compared with the prior art, the trigger mechanism of the animal trap has the advantages of simple structure, low failure rate and smaller component volume, and the animal trap can catch larger mice or other animals under the condition that the shell size of the trap is the same.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

What is claimed is:

1, A screw lifter which lifts a toy ball, comprising:
A base, a lifting assembly and a recycling assembly;
The base includes a base housing and a drive assembly, said base housing being provided with a first opening and a second opening;
Said lifting assembly comprising a screw mechanism, a lifting pipe and a lifting inlet and lifting outlet mounted on said lifting pipe, wherein said lifting assembly is mounted in said first opening, said screw mechanism is coupled to said drive assembly, and said lifting pipe surrounds the entire the screw mechanism;
Said recycling assembly comprising a recycling pipe and a recycling inlet and recycling outlet set on said recycling pipe, said recycling assembly being set in said second opening;
wherein the longitudinal height of said recycling inlet is not higher than the longitudinal height of said lifting outlet and the longitudinal height of said recycling outlet is not lower than the longitudinal height of said lifting inlet;
Wherein when the screw mechanism is actuated by said drive assembly, said screw mechanism can lift the toy ball entering from the lifting inlet and lift it to the lifting outlet;
When said toy ball enters into said recycling pipe through said recycling inlet, said toy ball relying on its own gravity reaches said recycling outlet, exits from said recycling outlet into said lifting inlet, and is thereby lifted again by said screw mechanism, completing the reciprocating cyclic movement.

2, A screw lifter which lifts a toy ball according to claim 1, wherein said drive assembly comprises battery slot, motor and gear set;

3, A screw lifter which lifts a toy ball according to claim 2, wherein said battery slot is further provided with a battery cover, said battery cover being detachably connected to said battery slot and screwed to said battery slot;

4, A screw lifter which lifts a toy ball according to claim 2, wherein torque is transferred between said motor and said gear set by means of gear torsion member;

5, A screw lifter which lifts a toy ball according to claim 1, wherein both said first opening and said second opening are configured as vertical pipes extending upwardly;

6, A screw lifter which lifts a toy ball according to claim 1, wherein said screw mechanism comprises a plurality of sections screw rod, each of said screw rod comprising central shaft, screw guide disposed around said central shaft, and connecting groove disposed at an end of said screw rod;

7, A screw lifter which lifts a toy ball according to claim 6, wherein said screw mechanism further comprises a triangular pin forming a transmission connection between each two sections of said screw rod by means of said triangular pin, wherein the ends of said triangular pin extend into said connecting groove of said screw rod of two adjacent sections of said screw rod, such that the two adjacent sections of said screw rod ends may be in contact, realizing a solid structure design;

8, A screw lifter which lifts a toy ball according to claim 6, wherein said screw mechanism is provided with a limiting block at the top, the shape of said limiting block is set as a cylindrical shape at the upper portion and an inverted conical shape at the lower portion, and the highest height at which said toy ball rises within said lifting pipe is the location that said limiting block is located;

9, A screw lifter which lifts a toy ball according to claim 8, wherein said limiting block is provided with an external portion above said limiting block, the lower portion of said external portion extending into said limiting block so that said external portion can rotate synchronously with said screw mechanism;

10, A screw lifter which lifts a toy ball according to claim 1, wherein said lifting pipe consists of a plurality of sections lifting pipe unit connected together, each section of said lifting pipe unit comprising main body portion and holding portion;

11, A screw lifter which lifts a toy ball according to claim 10, wherein one end of said lifting pipe unit is provided with joint and the inner wall of said joint is provided with protruding block so that said lifting pipe unit can be inserted into each other;

12, A screw lifter which lifts a toy ball according to claim 10, wherein the lower end of said lifting pipe is inserted into said first opening and that said lifting inlet is set at the bottom of said lifting pipe and said lifting outlet is set at the top of said lifting pipe;

13, A screw lifter which lifts a toy ball according to claim 1, wherein said recycling inlet is set at the top of said recycling pipe and said recycling outlet is set at the bottom of said recycling pipe;

14, A screw lifter which lifts a toy ball according to claim 1, wherein a lower portion of said recycling pipe is sleeved over said second opening, and said recycling pipe comprises a plurality of recycling pipe unit, each recycling pipe unit being provided with a joint at one end such that said recycling pipe unit can be inserted into each other;

15, A screw lifter which lifts a toy ball according to claim 1, wherein said lifting assembly and said recycling assembly are connected to each other by two chute's, two said chute's being provided between said recycling outlet and said lifting inlet, and between said recycling inlet and said lifting outlet, respectively;

16, A screw lifter which lifts a toy ball, comprising:
A base, a lifting assembly and a recycling assembly;
Said base comprising a base housing and a drive assembly, said base housing being provided with a first opening and a second opening;
Said lifting assembly comprising a screw mechanism, a lifting pipe and a lifting inlet and lifting outlet set on said lifting pipe, wherein said lifting assembly is set in said first opening, said screw mechanism is coupled to said drive assembly, said lifting pipe encompasses the whole of said screw mechanism, and said lifting pipe consists of a plurality of sections lifting pipe unit coupled together, said lifting pipe unit consisting in each section of a main body portion and a holding portion, one end of said lifting pipe unit being provided with joint and the inner wall of said joint being provided with a protruding block such that said lifting pipe unit can be plugged into each other;
Said recycling assembly comprising a recycling pipe and a recycling inlet and a recycling outlet provided on said recycling pipe, wherein said recycling assembly is provided in said second opening, said recycling pipe comprising a plurality of recycling pipe unit, each of said recycling pipe unit being provided with a joint at one end such that said recycling pipe unit can be interposed with each other;
wherein the longitudinal height of said recycling inlet is not higher than the longitudinal height of said lifting outlet and the longitudinal height of said recycling outlet is not lower than the longitudinal height of said lifting inlet;
When said screw mechanism is actuated by said drive assembly, said screw mechanism may lift toy ball entering from said lifting inlet and lift it to said lifting outlet;
When said toy ball enters said recycling pipe through said recycling inlet, said toy ball relying on its own gravity reaches said recycling outlet, exits said recycling outlet into said lifting inlet, and is thereby lifted again by said screw mechanism, completing the reciprocal cyclic motion.

17, A screw lifter which lifts a toy ball, comprising:
A base, a lifting assembly and a recycling assembly;
Said base includes a base housing and a drive assembly, said base housing being provided with a first opening and a second opening;
Said lifting assembly comprising a screw mechanism, lifting pipe and lifting inlet and lifting outlet set on said lifting pipe, wherein said lifting assembly is set in said first opening, said screw mechanism is coupled to said drive assembly, said lifting pipe encompasses the whole of said screw mechanism, said screw mechanism comprising a plurality of screw rods, each of said screw rods comprising a central shaft, a screw guide set around said central shaft and the screw guide provided around said central shaft and connecting groove provided at an end of said screw rod, said screw mechanism further comprising a triangular pin forming a transmission connection between every two sections of said screw rod by means of said triangular pin, wherein ends of said triangular pin extend into said connecting groove of two adjacent sections of said screw rod;
Said recycling assembly comprising a recycling pipe and said recycling inlet and recycling outlet provided in said recycling pipe, wherein said recycling assembly is provided in said second opening;
wherein the longitudinal height of said recycling inlet is not higher than the longitudinal height of said lifting outlet and the longitudinal height of said recycling outlet is not lower than the longitudinal height of said lifting inlet;
When said screw mechanism is actuated by said drive assembly, said screw mechanism may lift toy ball entering from said lifting inlet and lift it to said lifting outlet;
When said toy ball enters said recycling pipe through said recycling inlet, said toy ball relying on its own gravity reaches said recycling outlet, exits said recycling outlet into said lifting inlet, and is thereby lifted again by said screw mechanism, completing the reciprocal cyclic motion.
